(19) United States
(12) Patent Application Publication
(10) Pub. No.: US 2008/0198932 A1
(43) Pub. Date: Aug. 21, 2008

(54) Complexity-based rate control using adaptive prefilter

(75) Inventor: Kyojiro Sei, Yokohama (JP)

Correspondence Address: IMPERIUM PATENT WORKS, P.O. BOX 587, SUNOL, CA, 94586, US

(73) Assignee: NuCORE Technology Inc.

(21) Appl. No.: 11/709,645

(22) Filed: Feb. 21, 2007

(51) Int. Cl. H04N 7/12

(52) U.S. Cl. 375/240.16; 375/E07.031

(57) ABSTRACT

In an image capture device, a filter in a processing stage prior to an MPEG encoder applies unsharp masking and spatial filtering. MPEG encoder hardware that is used to determine SAD values also determines a complexity value. The complexity value indicates a complexity of a macroblock or a frame. The processor uses the complexity value to determine an appropriate transfer function of the spatial filter. The spatial filter smoothes information supplied to the MPEG encoder such that the MPEG encoder can apply less severe quantization, thereby reducing apparent block noise when the resulting MPEG video is later decoded and viewed on a display device.

### CROSS-REFERENCE TO RELATED APPLICATION

This application claims the benefit under 35 U.S.C. §119 of Provisional Application No. ______, entitled “Complexity-Based Rate Control Using Adaptive Prefilter”, by Kyojiro Sei, filed Feb. 9, 2007, Express Mail No. EB066109799US (the subject matter of which is incorporated herein by reference in its entirety).

### TECHNICAL FIELD

The present invention relates to reducing visible noise in video.

### BACKGROUND

The Moving Picture Experts Group (MPEG) is a working group of ISO/IEC responsible for the development of video and audio encoding standards. For publications describing MPEG encoding and decoding techniques, see, for example, “Digital Video and HDTV Algorithms and Interfaces”, Charles Poynton, The Morgan Kaufmann Series in Computer Graphics (2003) and “H.264 and MPEG-4 Video Compression: Video Coding for Next Generation Multimedia”, Iain E. G. Richardson, John Wiley and Sons (2003), which are incorporated herein by reference in their entirety. Encoding techniques such as MPEG reduce the amount of information used to represent video but can introduce noise that is visible during display of decoded video.

Under MPEG, video is represented as a group of “pictures”. FIG. 1 (Prior Art) is a representation of a group of “pictures” (also known as “frames”). Each picture can be one of three types: predicted pictures (P-pictures), intra-coded pictures (I-pictures), and bi-directionally coded pictures (B-pictures). I-pictures are encoded without respect to other pictures. Each P-picture or B-picture is encoded as a set of differences with respect to one or more reference pictures, which can be I-pictures or P-pictures.

Each picture is further divided into data sections known as “slices”, each consisting of a number of “macroblocks,” which are each organized as six or eight 8-pixel by 8-pixel (8×8) blocks. Under one level of color precision, a macroblock includes four 8×8 blocks of brightness (luminance) samples, two 8×8 blocks of “red” samples (“red-chrominance”), and two 8×8 blocks of “blue” (“blue-chrominance”) samples. Under this level of color precision, red-chrominance and blue-chrominance samples are sampled only half as often as the luminance samples. Under another level of color precision, a macroblock includes four 8×8 luminance blocks, four 8×8 red-chrominance blocks, and four 8×8 blue-chrominance blocks. Information regarding each macroblock is provided by a macroblock header which identifies (a) the position of the macroblock relative to the position of the most recently coded macroblock, (b) which of the 8×8 blocks within the macroblock are encoded as intra-blocks (i.e., without reference to blocks from other pictures), and (c) whether a new set of quantization constants is to be used.

FIG. 2 (Prior Art) depicts a high level simplified block diagram of an MPEG encoder. MPEG encoding techniques are well known. A frame of input video (F (0)) is provided to motion estimation block 2 and summer 4. For P and B pictures, motion estimation block 2 determines motion vectors (shown as “MV”) by comparing each of the new macroblocks in a frame of video with macroblocks in a previously stored reference frame or frames (F″ (1)). A motion vector expresses the horizontal and vertical displacement from the macroblock being encoded to the matching macroblock-sized area in the reference picture.

Motion estimation block 2 determines complexity of one or more frames. In one usage of the term, complexity is referred to in the prior art as “activity” or “motion intensity”. Complexity describes a level of motion in one or more frames. Low complexity means few objects move at slow speeds whereas high complexity means one or more objects moves at moderate to high speeds. In one known implementation, a complexity descriptor measures intensity of motion based on standard deviations of motion-vector magnitudes. Direction of motion, spatial distribution of motion activity, and temporal distribution of motion activity can also be used to determine complexity.

Motion compensation block 6 encodes a frame based on other video frames temporally close to it. Motion compensation block 6 provides a motion compensated predicted frame, F′ (0), based on the motion vector (MV) and a previously stored reference frame (F″ (1)).

In the cases of P and B pictures, summer 4 provides signal D(0) which represents the difference (also known as “residual”) between the predicted macroblock (from frame F′ (0) provided by motion compensation block 6) and the actual macroblock being encoded (from frame F (0)) on a pixel by pixel basis. In the case of I pictures, no motion estimation occurs and the (−) input to summer 4 is zero.

DCT block 8 transforms pixel blocks into the frequency domain using a 2-dimensional discrete cosine transform (DCT). The applicable 2-dimensional DCT consists of a “horizontal” and a “vertical” spatial DCT. DCT represents the luminance or chrominance values of a block as a set of coefficients in a sum of cosine functions. The discrete cosine transform (DCT) is the sampled version of the cosine transform and is used extensively in two-dimensional form in MPEG. A block of 8×8 pixels is transformed to become a block of 8×8 DCT coefficients.

Quantization block 10 quantizes each coefficient of the block in the frequency space using constants from a quantization table. In quantization, the coefficients are divided by constants that are a function of frequency in two dimensions. Low-frequency coefficients are divided by small numbers, whereas high frequency coefficients are divided by large numbers. The least-significant bit is discarded or truncated. Multiple quantization tables can be available for use by quantization block 10. A quantization table and its constants can be selected for use to achieve an average desired bit rate output by the MPEG encoder. Quantization block 10 provides quantized coefficient block G(0) to coding block 12 and inverse quantization block 16.

For the P and I pictures, the quantized DCT coefficients are routed to a decoding loop (i.e., inverse quantization 16 and IDCT 18) that decodes coefficients. The predicted macroblock from frame F′ (0) is added to a decoded residual or actual block from D′ (0) on a pixel by pixel basis and stored into frame storage block 22 among frame F″ (0) to serve as a reference for predicting subsequent pictures.

Coding block 12 converts 2-dimensional blocks into a linear list of values by scanning the values of the 8×8 block under a “zigzag scanning order.” All non-zero coefficients, other than the DC-coefficient, are then represented using a “run-level” coding. The “run-level” encoded lists are transformed into variable-length codes using a Huffman coding technique.

Buffer 14 indicates bit count per macroblock to rate control block 24. Rate control block 24 controls the quantization levels applied by quantization block 10 to achieve a desired bit rate. For example, if the current bit count per macroblock is too large then the average bit rate may be too high. Coefficients can be divided by larger numbers to reduce the average bit rate to be an acceptable level.

Video with high levels of motion can increase the average bit rate, which can lead to an increase in the magnitude of numbers used in quantization to reduce the bit rate. However, dividing coefficients by too large numbers can introduce noise in video that can be visible to the human eye. For example, two types of noise that can be introduced are “block noise” and “mosquito noise” (also known as “Gibbs effect”). In “block noise” or “blockiness”, boundaries around macroblocks are visible.

FIG. 3A (Prior Art) shows an example of an image of a person riding a bicycle where the image displays “block noise”. Mosquito noise appears as haziness and/or shimmering around edges of images.

FIG. 3B (Prior Art) shows an example of an image of a black and white striped object that suffers mosquito noise.

FIG. 4 (Prior Art) shows a high level simplified block diagram of a portion of a Digital Imaging Pipeline (DIP) pre-processor that performs edge enhancement on video prior to MPEG encoding. See, for example, U.S. patent application Ser. No. 10/981,213, entitled: “Continuous Burst Mode Digital Camera”, inventor Flory et al., filed Nov. 4, 2004, which is incorporated herein by reference in its entirety. Sensor 30 captures video and provides video in the Bayer format. Pre-processor 32 processes video and provides processed video to MPEG encoder 34. MPEG encoder 34 encodes video in the MPEG format.

Pre-processor 32 includes interpolation block, color matrix block, gamma correction block, and edge enhancement block. Collectively, interpolation block, color matrix block, and gamma correction block perform Bayer-to-RGB conversion, white balance, color correction, gamma correction, and RGB-to-YUV color space conversion. Edge enhancement block enhances edges using an unsharp mask. The unsharp mask creates a slightly blurred version of the original image and the slightly blurred version is subtracted from the original image to detect the presence of edges, creating the unsharp mask. The unsharp mask is effectively a high-pass filter. Contrast is then selectively increased along these edges using this mask thereby leaving behind a sharper final image. However, MPEG encoder block 34 introduces block noise and mosquito noise into the video from pre-processor 32, which are visible when the video is played back.

FIG. 5 (Prior Art) shows a high level simplified block diagram of a prior art MPEG decoder system that uses a de-blocking filter 42 to reduce block noise. De-blocking filter 42 reduces block noise by application of a low pass filter to blend (to “smooth”) the edges of each block with those of its neighbors and thereby hide block noise. However, not all video playback devices utilize a de-blocking filter. For example, some personal computers or Digital Versatile Disc (DVD) player devices do not utilize a de-blocking filter at video play back and accordingly block noise and mosquito noise can be visible in video.

It is desirable to reduce noise introduced during video encoding.

### SUMMARY

A novel apparatus includes a video encoder that indicates at least one characteristic of a first portion of video during encoding of the first portion, a processor that determines a filter control value based in part on the at least one characteristic, and a pre-processing block that receives a second portion of video and applies filtering to the second portion prior to providing the second portion to the video encoder. A transfer function of the filtering is based in part on the filter control value. In one embodiment, the transfer function is bell-shaped and decreases in gain as horizontal or vertical spatial frequency increase. The video encoder applies MPEG encoding. In one embodiment, the characteristic of video is any of: macroblock complexity, frame complexity, and/or a quantization value for the frame. In one example, the first portion of video is a frame and the second portion of video is another frame and the filtering performed by the pre-processing block is spatial filtering.

In one embodiment, hardware performs unsharp masking and this same hardware is also used to perform the spatial filtering that is applied to the video before the video is supplied to the video encoder. In one example, the hardware is a digital filter within a Digital Back End (DBE) integrated circuit within a digital camera.

A novel pixel processing method includes determining at least one characteristic of video during encoding of the video. The at least one characteristic is used to control pre-filtering of the video prior to video encoding based on the at least one characteristic of video. In one embodiment, the MPEG encoding is MPEG-4 encoding. In one embodiment, controlling the pre-filter controls a three-dimensional shape of a transfer function applied by the pre-filter. In one embodiment, the transfer function is based on any of: macroblock complexity, frame complexity, and/or a quantization value for the frame.

In one advantageous aspect, video encoder hardware used to encode video generates intermediate data and the intermediate data is used to control a pre-filter for rate control purposes. In one example, the intermediate data is used both in the motion estimation portion of the video encoding process as well as to control the pre-filter.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) is a representation of a group of “pictures” or “frames”.

FIG. 2 (Prior Art) depicts a high level simplified block diagram of an MPEG encoder.

FIG. 3A (Prior Art) shows an example of an image of a person riding a bicycle where the image displays “block noise”.

FIG. 3B (Prior Art) shows an example of an image of a black and white striped object that suffers mosquito noise.

FIG. 4 (Prior Art) shows a high level simplified block diagram of a portion of a Digital Imaging Pipeline pre-processor that performs edge enhancement on video prior to MPEG encoding.

FIG. 5 (Prior Art) shows a high level simplified block diagram of a prior art MPEG decoder system that uses a de-blocking filter to reduce block noise.

FIG. 6 is a high level simplified diagram of an image capture device 100, in accordance with an embodiment of the present invention.

FIG. 7 is a high level simplified diagram that shows image processing integrated circuit 103 in more detail, in accordance with an embodiment of the present invention.

FIG. 8 is a high level simplified diagram that shows digital imaging pipeline (DIP) circuit block 112 in more detail, in accordance with an embodiment of the present invention.

FIG. 9 is a high level simplified diagram of DIP pipeline 124 in more detail, in accordance with an embodiment of the present invention.

FIG. 10 is a high level simplified diagram of a system that reduces block noise and mosquito noise introduced during video encoding, in accordance with an embodiment of the present invention.

FIG. 10A is a graph that illustrates one way that a frame quantization value QP can be converted into a filter control value.

FIG. 11A shows an example of a three-dimensional transfer function applied in spatial filtering, in accordance with an embodiment of the present invention.

FIG. 11B depicts a top down perspective of a spatial filter transfer function where the diagonal is controlled, in accordance with an embodiment of the present invention.

FIG. 11C depicts two-dimensional horizontal and vertical dimension transfer functions that can be applied in spatial filtering, in accordance with an embodiment of the present invention.

FIG. 12 depicts a high level simplified diagram of a pre-filter that applies unsharp mask and spatial filtering, in accordance with an embodiment of the present invention.

FIG. 13 is a flowchart of a method that can be used to determine filter coefficients, in accordance with an embodiment of the present invention.

FIG. 14 is a high level block diagram illustration of how the system of FIG. 10 applies filter control values to a frame based on processing of at least one other frame, in accordance with an embodiment of the present invention.

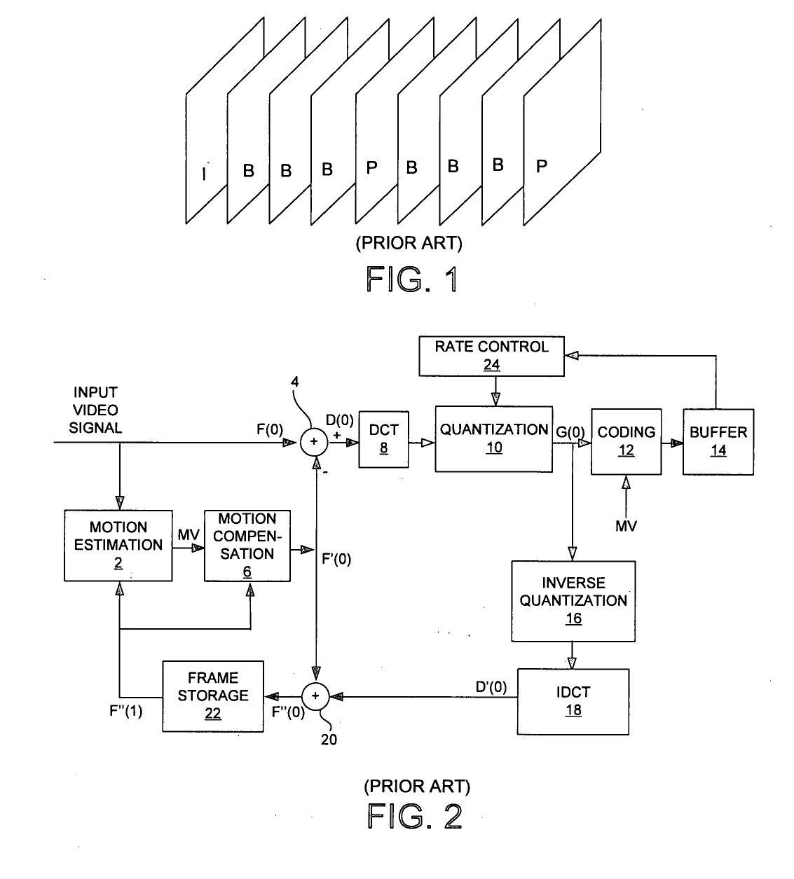

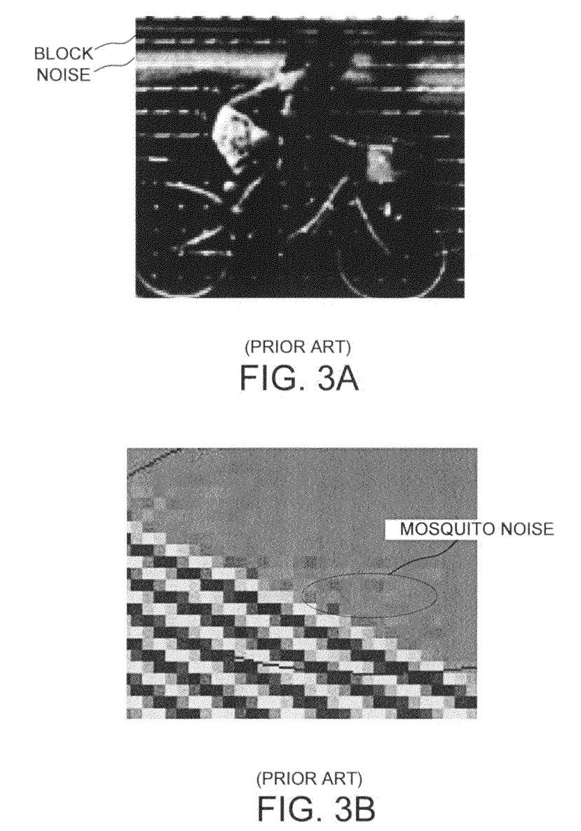

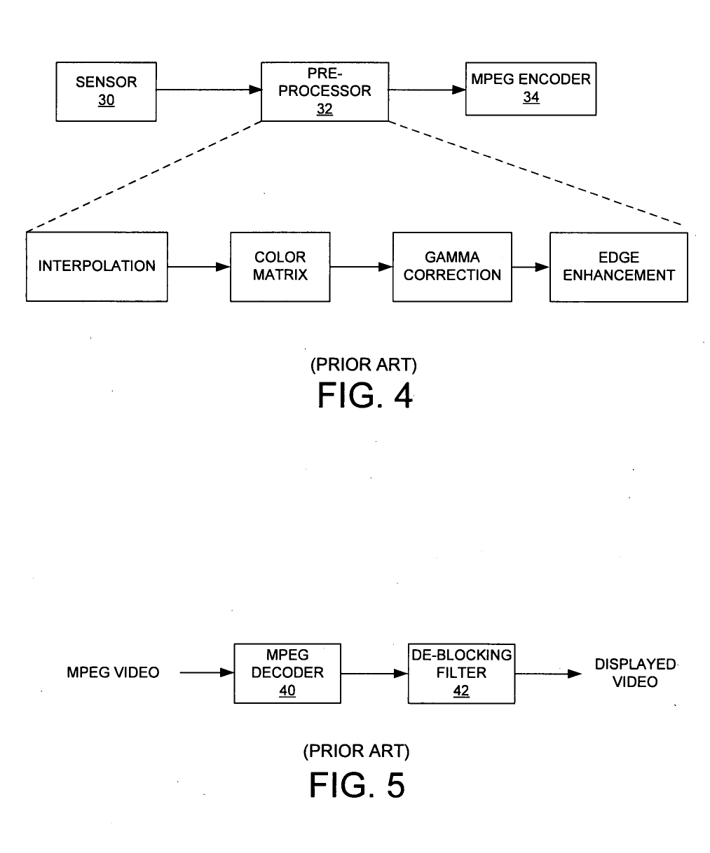

### DETAILED DESCRIPTION

Reference will now be made in detail to some embodiments of the invention, examples of which are illustrated in the accompanying drawings.

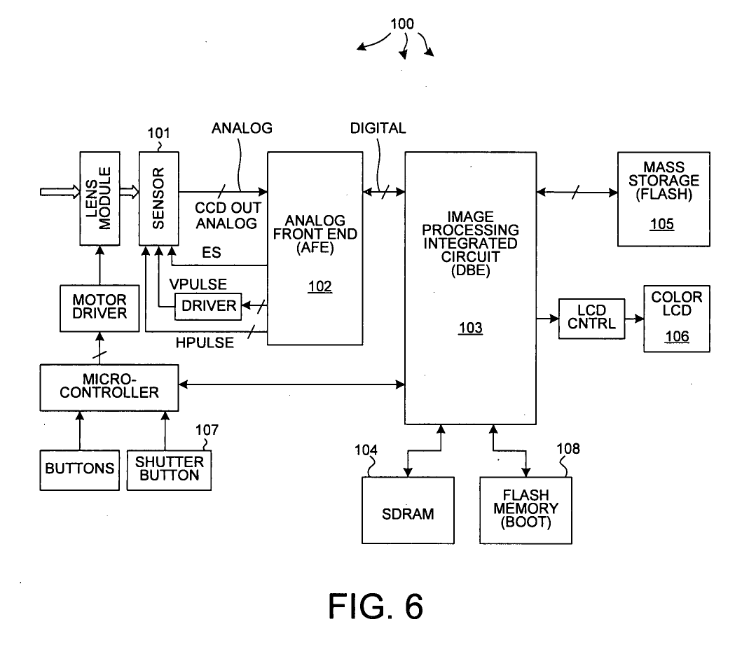

FIG. 6 is a high level simplified diagram of an image capture device 100 in accordance with one novel aspect. The term “image” can refer to a still image, video, or a sequence of still images that is visible as video (e.g., motion JPEG). An image is captured by an image sensor 101. Analog image data from image sensor 101 is digitized by analog-front end (AFE) integrated circuit 102. The resulting digital image data is passed to image processing integrated circuit 103 (also referred to as a “digital back end” or “DBE”) and is stored in SDRAM 104. Image processing integrated circuit 103 then reads the image data back out of SDRAM 104 and performs many different types of image processing on the image data, and then compresses the resulting image data into a file, and stores the image data in the form of a compressed file into mass storage 105. In one embodiment, an implementation of image processing integrated circuit 103 is described in: U.S. patent application Ser. No. 11/599,205, entitled “DYNAMIC TILE SIZING IN AN IMAGE PIPELINE”, inventor Arora, filed Nov. 13, 2006, attorney docket number NCT-014, which is incorporated herein by reference in its entirety. Mass storage 105 may, for example, be an amount of removable non-volatile memory such as flash memory. As the user of the image capture device 100 is moving the camera around to compose a digital photograph to be captured, the digital camera operates in a preview mode and displays on LCD display 106 an image of what the digital photograph would look like were the shutter button 107 to be pressed and an actual high resolution digital image were to be captured. Image processing integrated circuit 103 includes a digital processor that executes programs of processor-executable instructions. These programs are initially stored in non-volatile boot memory 108. When the digital camera is turned on for use, one or more these programs that are to be executed are read out of boot memory 108 and are transferred to SDRAM 104. The processor then executes the programs out of SDRAM 104.

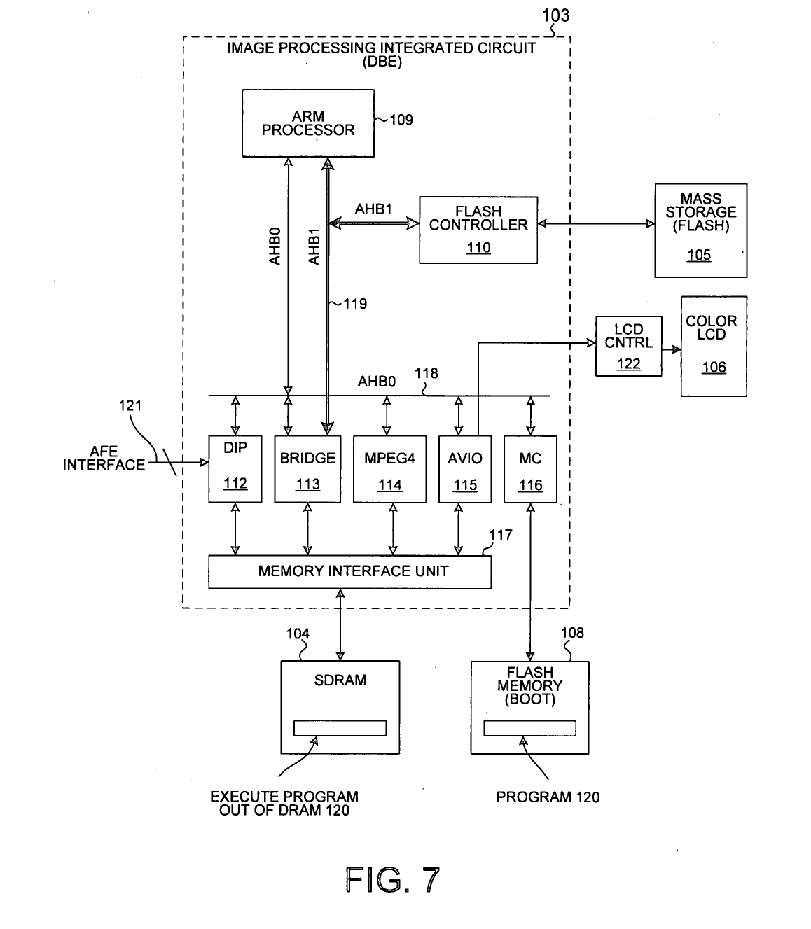

FIG. 7 is a high level simplified diagram that shows image processing integrated circuit 103 in more detail, in accordance with an embodiment of the present invention. Image processing integrated circuit 103 includes a processor 109, a flash memory controller 110, a digital imaging pipeline (DIP) circuit 112, a bridge 113, an MPEG4 encoder/decoder circuit 114, an AVIO circuit 115, a second flash memory controller 116, and a memory interface unit (MIU) 117. Processor 109 is coupled to the various other circuits 112-116 (other than MIU 117) by parallel AHB0 and AHB1 busses 118 and 119 as illustrated. When the digital camera is turned on for use, filter transfer function program 120 is read out of boot memory 108 by memory controller 116 and is transferred across AHB0 bus 118 to bridge 113 and from bridge 113 through MIU 117 into SDRAM 104. Other programs can be read out of boot memory such as rate control software 175. Once this transfer has occurred during booting of the camera, processor 109 can then execute program 120 out of SDRAM 104. In an embodiment, program 120 determines properties of a transfer function applied in spatial filtering by DIP 112. Image data from AFE 102 is received into the digital imaging pipeline (DIP) circuit 112 across a set of digital input leads 121 as illustrated. Information to be displayed on the LCD display 106 of the camera is output from IC 103 by AVIO circuit 115 to LCD controller 122, which in turn drives LCD display 106.

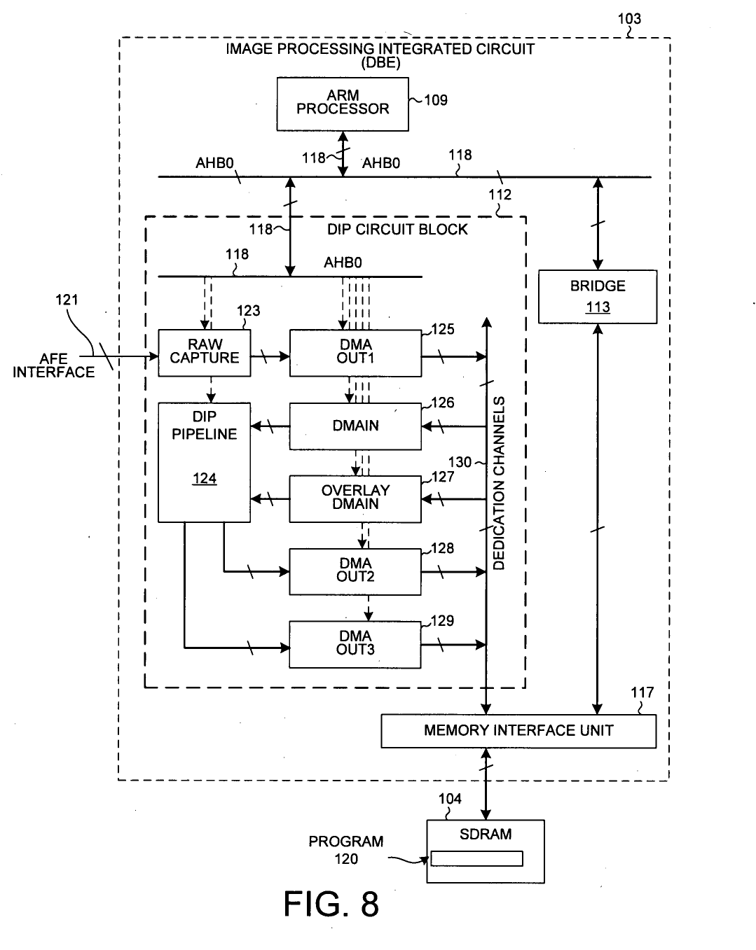

FIG. 8 is a high level simplified diagram that shows digital imaging pipeline (DIP) circuit block 112 in more detail, in accordance with an embodiment of the present invention. DIP circuit block 112 includes a raw capture block 123, the actual digital imaging pipeline (DIP pipeline) 124, a first direct memory access output block (DMA OUT1) 125, a direct memory access input block (DMAIN) 126, an overlay direct memory access input block (OVERLAY DMAIN) 127, a second direct memory access output block (DMA OUT2) 128, and a third direct memory access output block (DMA OUT3) 129. Processor 109 can write and read information, including control information, into and out of control registers in each of the blocks 123-129 across AHB0 bus 118. The dashed vertically extending lines in FIG. 8 illustrate the writing of control information into blocks 123-129 by processor 109 via AHB0 bus 118. The DMA blocks 125-129 can transfer image data to and from memory 104 via parallel bus 130 and MIU 117. Image data coming in from AFE 102 flows into image processing integrated circuit 103 via AFE interface leads 121 and to raw capture block 123. DMA OUT1 block 125 and MIU 117 function together to transfer the image data from raw capture block 123, through DMA OUT1 block 125, across bus 130 of dedicated channels, and through MIU 117 to memory 104. Image data to be processed is then transferred by MIU 117 and DMAIN block 126 back out of memory 104, through MIU 117, across bus 130, through DMAIN block 126 and to DIP pipeline 124. Information to be overlayed, if there is any, is transferred by MIU 117 and OVERLAY DMAIN 127 from memory 104, through MIU 117, across bus 130, through OVERLAY DMAIN block 127, and into DIP pipeline 124. Once the image data has been processed by DIP pipeline 124, it is transferred back to memory 104 by one or both of two paths. Either the processed image data passes through DMA OUT2 block 128, across bus 130, and through MIU 117, and into memory 104, and/or the processed image data passes through DMA OUT3 block 129, across bus 130, and through MIU 117, and into memory 104. Processor 109 fetches instructions of program 120 and accesses data from memory 104 via AHB0 bus 118, bridge 113, and MIU 117.

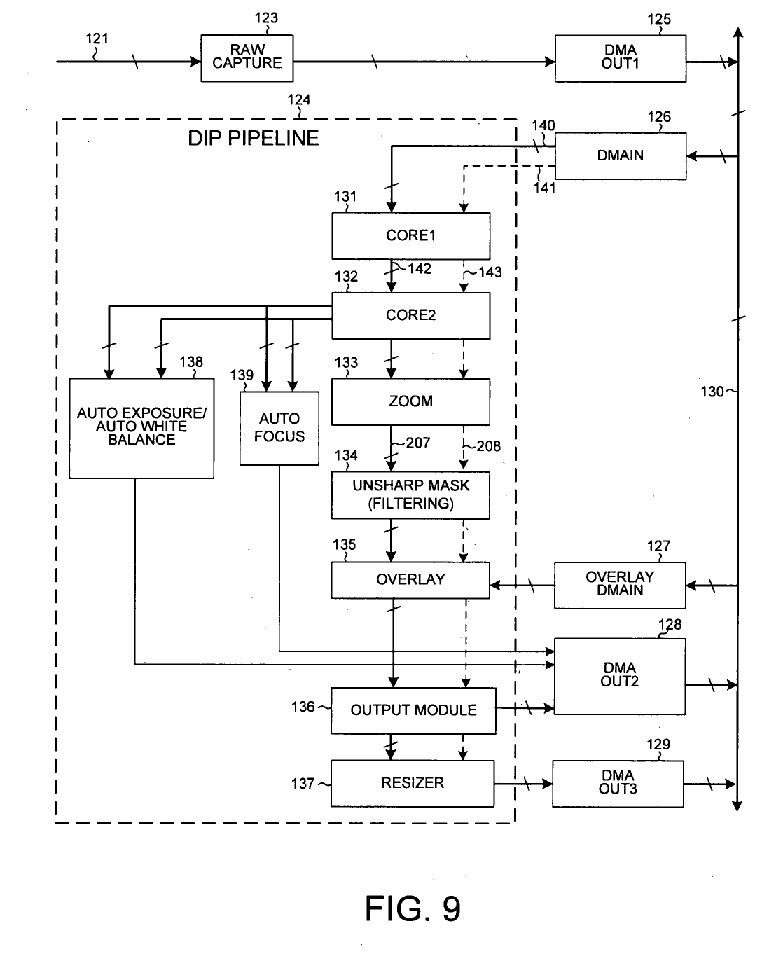

FIG. 9 illustrates a high level simplified diagram of DIP pipeline 124 in more detail, in accordance with an embodiment of the present invention. DIP pipeline 124 is an image pipeline that includes a number of stages 131-139. Stage 131 is a stage called “CORE1”. Stage 132 is a stage called “CORE2”. Stage 133 is a stage that performs a zoom function. The pixel values of a pixel block are transferred to the unsharp mask (filtering) stage 134 via parallel data lines 207 and control lines 172. Stage 134 is a stage that performs an unsharp mask function. In an embodiment, stage 134 includes a digital N tap filter. Stage 135 is a stage that performs an overlay function. Stage 136 is an output module stage. Stage 137 is a stage that performs resizing. Pipeline 124 also includes a stage 138 that performs an autoexposure/autowhite balance function, and a stage 139 that performs an autofocus function. Pixels of image data are transferred from DMAIN block 126 to stage 131 using parallel data lines 140 and control lines 141. Control lines 141, in this example, include a clock signal (CLK), a start of tile signal (SOT), an end of line signal (EOL), an end of tile signal (EOT), and a data enable or data valid signal (DATA_EN). Each successive one of stages 131-136 has its own similar set of parallel data lines and associated control lines for communicating pixels of image data to the next stage in the pipeline. For example, parallel data lines 142 and control lines 143 are used to communicate pixels of image data from stage 131 to stage 132.

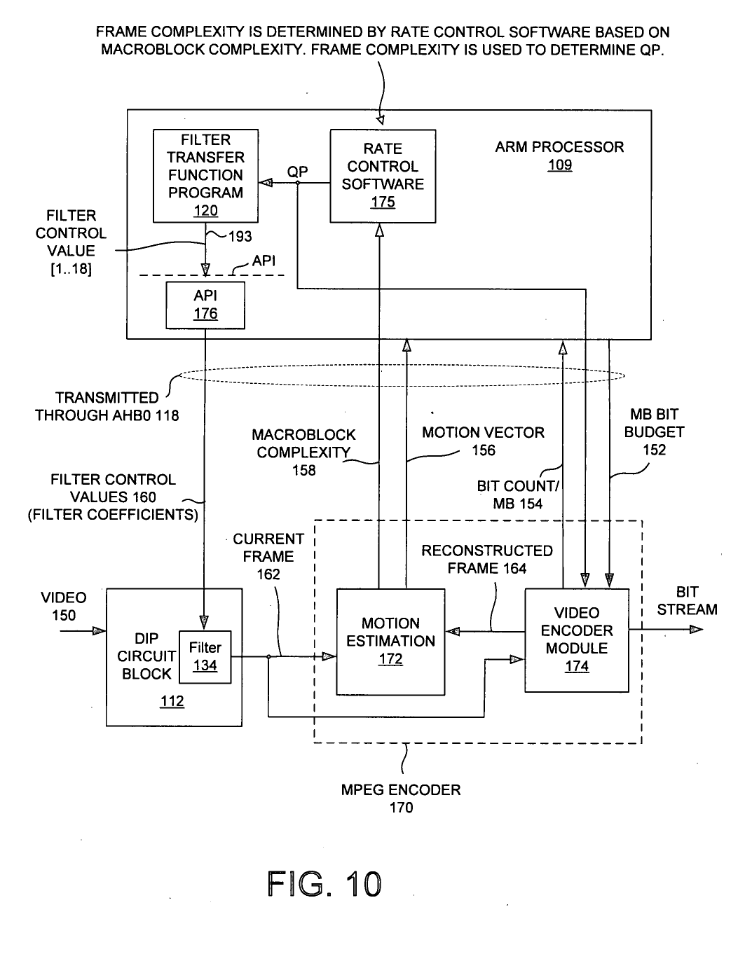

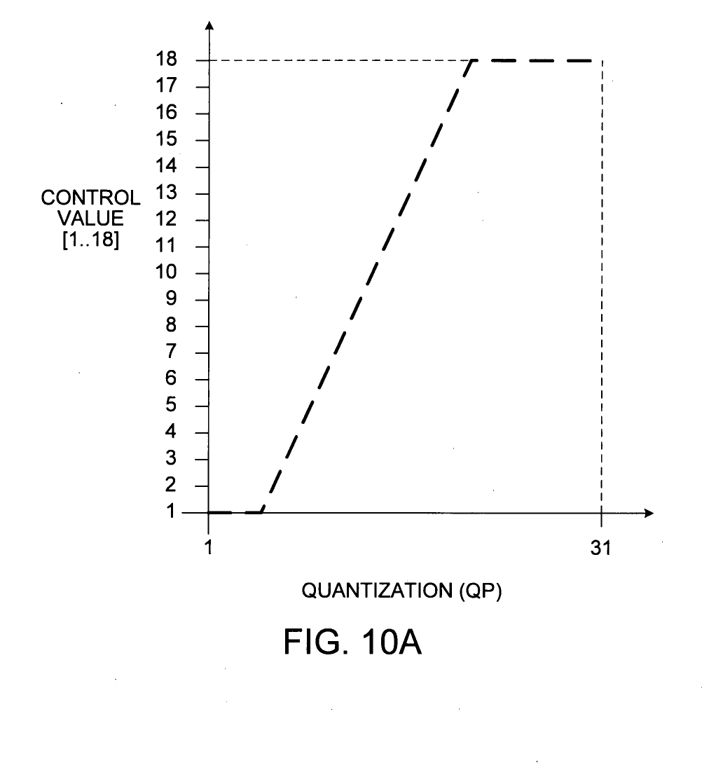

FIG. 10 is a high level simplified diagram of a system that reduces block noise and mosquito noise introduced during video encoding, in accordance with an embodiment of the present invention. DIP circuit block 112 receives digitized video 150 for example from an AFE integrated circuit 102 (see FIG. 6) via AFE interface 121 (see FIG. 7). For example, DIP circuit block 112 applies to the video any of: Bayer-to-RGB conversion, white balance, color correction, gamma correction, and RGB-to-YUV color space conversion. In one embodiment, filter 134 is a digital N-tap filter that applies unsharp masking and spatial filtering to a block of pixels. Unsharp masking enhances or smoothes edges of images. In one example, the transfer function applied by filter 134 is determined by the filter control values 160, and the filter control values 160 include filter coefficients.

Spatial filtering reduces the luminance in the edges of an object in a picture. In an embodiment, spatial filtering is applied to luminance frames but not to chrominance frames. In another embodiment, spatial filtering is applied to both luminance and chrominance frames. Consequently, MPEG encoder 170 receives and encodes frames having reduced complexity (and lower bit rate) than it otherwise would were spatial filtering not applied. Consequently, MPEG encoder 170 applies less severe quantization for a given desired bit rate. By applying less severe quantization, less block noise and mosquito noise are present in video during playback. A small reduction in detail of a picture leads to major reduction in block noise and mosquito noise.

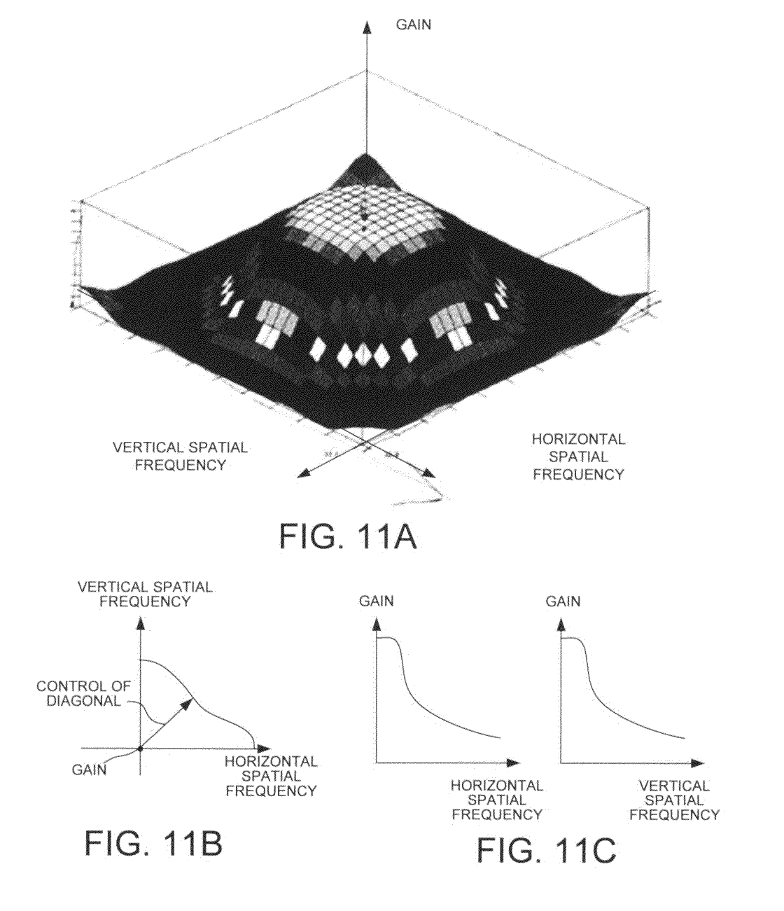

In one example, spatial filtering applies a three-dimensional transfer function that is bell-like in shape such that the gain applied to pixel values diminishes with increasing horizontal or vertical spatial frequencies. For example, FIG. 11A shows an example of a three-dimensional transfer function applied in spatial filtering, in accordance with an embodiment of the present invention. In one example, the axis representing gain extends through the center of the transfer function. However, the transfer function need not be symmetrical in shape.

In an embodiment, the shape of the transfer function applied by spatial filtering depends on the filter control values 160 provided by processor 109. The shape of the transfer function can be adjusted along any axis. For example, the shape can be adjusted diagonally between the horizontal and vertical axes based on filter control values 160. For example, FIG. 11B depicts a top down perspective of a spatial filter transfer function where the diagonal dimension is controlled, in accordance with an embodiment of the present invention. In an embodiment, the transfer function of the spatial filter can be changed as frequently as within the same frame or for each different frame. The different frame can be the next processed sequential frame or next processed non-sequential frame.

In an embodiment, rather than apply three-dimensional filtering, spatial filtering is applied first using a two-dimensional filter in the horizontal direction and then using a two-dimensional filter in the vertical direction. In an embodiment, rather than apply three-dimensional filtering, spatial filtering is applied first using a two-dimensional filter in the vertical direction and then using a two-dimensional filter in the horizontal direction. For example, FIG. 11C depicts two-dimensional horizontal and vertical dimension transfer functions that can be applied in spatial filtering, in accordance with an embodiment of the present invention.

Referring to FIG. 10, in one embodiment, MPEG encoder 170 encodes video in accordance with the MPEG-4 standard. In other embodiments, MPEG encoder 170 encodes video using MPEG-1 or MPEG-2, or other encoding standards that utilize quantization. MPEG encoder 170 includes motion estimation block 172 and video encoder module 174. Motion estimation block 172 is implemented as motion estimation block 2 of FIG. 2. Motion estimation 172 determines and provides to processor 109 a motion vector 156 for at least one macroblock in current frame 162. Motion vector 156 conveys a motion vector for every macroblock in current frame 162. Motion estimation 172 determines and provides to processor 109 a macroblock complexity 158 for each macroblock.

In one example, motion estimation 172 scans a reference frame for pixels and determines a sum of absolute difference (SAD) value for a macroblock in current frame 162 as compared to similar sized regions in a reference frame. The region in the reference frame associated with the smallest SAD is used to determine the motion vector for the macroblock. In addition, motion estimation 172 determines an average A of all the pixel values in the macroblock in the current frame 162. Motion estimation engine 172 then, for each pixel value in the macroblock, determines a difference D between the pixel value and the average A. The sum of all these differences D is the determined a “macroblock complexity” value 158 of the macroblock in the current frame 162. In one advantageous aspect, the same hardware in motion estimation block 172 that calculates the SAD value for the motion vector determination also calculates each macroblock complexity value 158. ARM processor 109 determines the “frame complexity” value by summing all the “macroblock complexity” values 158 of all the macroblocks in the current frame 162.

In another example of determining frame complexity, frame complexity is determined based on motion vectors. Motion estimation 172 determines and provides to processor 109 a motion vector 156 for at least one macroblock in current frame 162. Motion vector 156 may be a motion vector for some or all macroblocks in current frame-162. For example, motion estimation block 172 or processor 109 may determine a frame complexity level based on the magnitude of motion vectors for some or all of the macroblocks in current frame 162 and/or the number of motion vectors present in current frame 162. For example, if the magnitude of motion vectors and number of motion vectors present in current frame 162 are high, then complexity is high. For example, if the magnitude of motion vectors and number of motion vectors present in current frame 162 are low, then frame complexity is low.

In another example of determining frame complexity, the SAD values for all macroblocks in the current frame are considered. If the smallest one of the SAD values is above a predetermined threshold, then frame complexity is determined to be large enough to change filter coefficients. Changing filter coefficients increases smoothing of the frame.

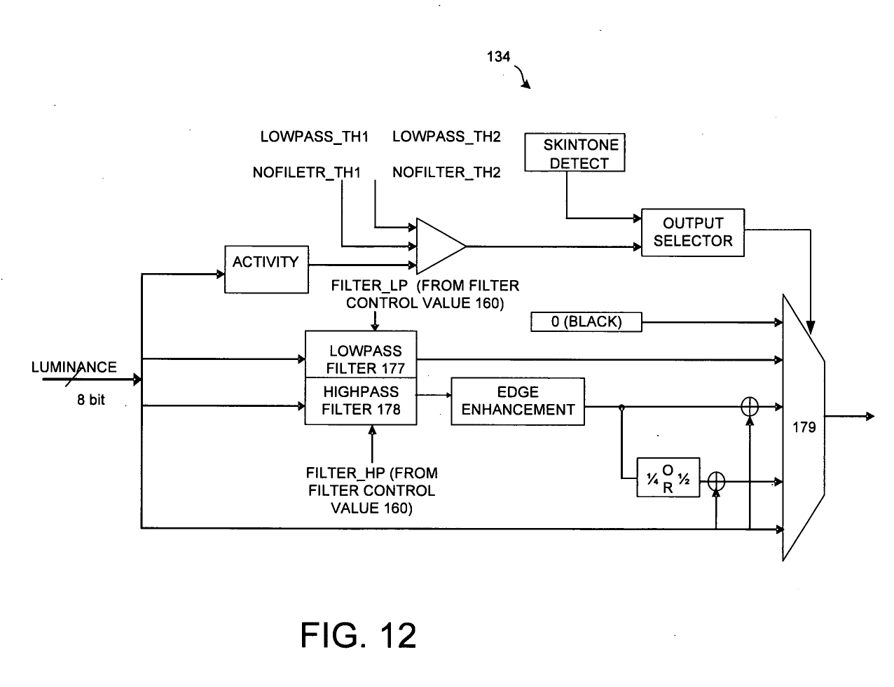

In another example of determining frame complexity, if a face is detected in a frame (as determined by the skintone detect block of FIG. 12), then frame complexity for the frame is determined to be low so that the pre-filter will not perform a smoothing function on the entire frame to reduce bit rate. This is advantageous in a security camera use where hours of video are to be captured and a low bit rate is desirable when there is no face in the frames of the video. But if a face is present in a frame, then the smoothing function is turned-off (or reduced) so that as much detail of the face is captured as possible.

Video encoder module 174 is implemented using buffer block 14 and rate control block 24 from FIG. 2. Macroblock (MB) bit budget 152 is the number of bits permissible to be allocated to a macroblock taking into account the current bit rate and the desire to maintain a particular output bit rate. Bit count/MB 154 is the number of bits in the current macroblock.

Processor 109 receives current bit count per MB 154 from video encoder module 174 as well as motion vector 156 and macroblock complexity 158 from motion estimation block 172. Processor 109 determines MB bit budget 152 and provides MB bit budget 152 to video encoder module 174.

Processor 109 uses the “frame complexity” value (frame complexity in this example is the sum of the macroblock complexity values for all the macroblocks in current frame 162) to determine a frame quantization value QP. As illustrated in FIG. 10, the frame quantization value QP is supplied to video encode module 174. The frame quantization value QP is also supplied to filter transfer function program 120. Filter transfer function program 120 converts the quantization value QP into filter control value 193. The control value is a number that ranges from 1 to 18. In general, the higher the control value, the more smoothing and attenuation filter 134 applies to pixel values.

FIG. 10A is a diagram that illustrates one way that filter transfer function program 120 can convert the quantization value QP into filter control value 193. Filter control value 193 is supplied to an application program interface (API) program 176. API program 176 uses a look-up-table to convert filter control value 193 into a corresponding set of filter control values 160. In one example, the set of filter control values are filter coefficients for a low pass filter FILTER_LP and a high pass filter FILTER_HP within filter block 134. The filter coefficients control the shape (see FIG. 11A) of the transfer function of filter 134. Accordingly, if filter 134 is controlled to apply more smoothing, then the QP value causes video encoder module 174 to apply less severe quantization, whereas if filter 134 is controlled to apply less smoothing, then the QP value causes video encoder module 174 to apply more severe quantization. By regulating the reducing the degree of quantization in this fashion, block noise is reduced when the resulting MPEG-4 video information is later decoded and rendered as video.

Macroblock bit budget 152, bit count per macroblock 154, motion vector 156, and macroblock complexity 158 are determined for a current frame and filter 134 applies a spatial filtering based on the filter control value for a next sequential or non-sequential frame.

Filter control values 160, macroblock complexity 158, motion vector 156, bit count per MB 154, and MB bit budget 152 are transferred either to or from processor 109 across AHB0 bus 118. In an embodiment, DIP circuit block 112 and MPEG encoding block 170 are implemented in one integrated circuit.

FIG. 12 is a high level block diagram of one embodiment of filter 134. Filter control value 160 includes coefficients used by low pass filter 177 and high pass filter 178. In FIG. 12, FILTER_LP and FILTER_HP are these coefficients used by respective low pass filter 177 and high pass filter 178. In an embodiment, multiplexer 179 is switched at frame boundaries so that filter coefficients are changed frame-to-frame.

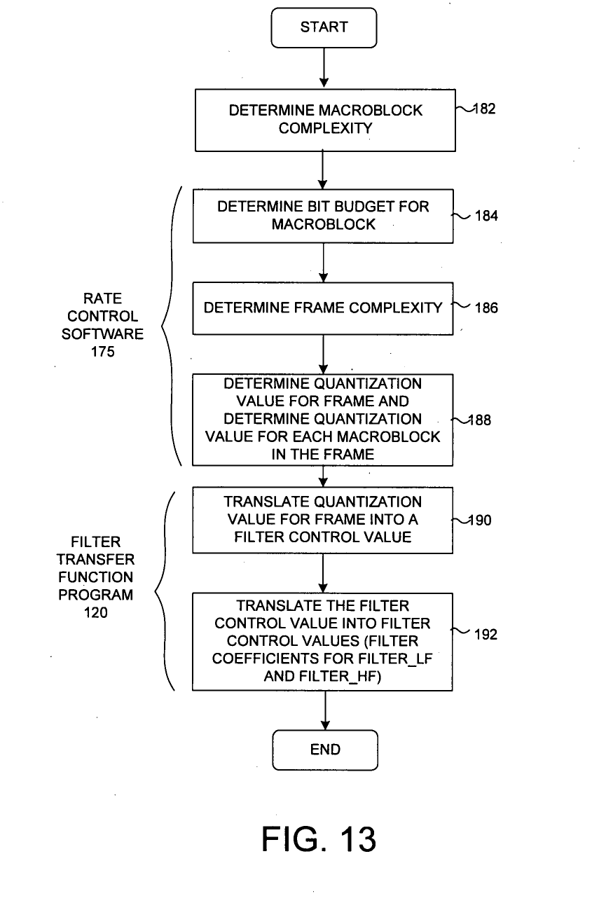

FIG. 13 is a flowchart of a method that can be used to determine filter coefficients (filter control values 160), in accordance with an embodiment of the present invention. In action 182, motion estimation block 172 determines macroblock complexity 158 for a macroblock in a current frame 162. In action 184, processor 109 uses rate control software 175 to determine a macroblock bit budget 152 for a current macroblock. In action 186, processor 109 uses rate control software 175 to determine frame complexity for current frame 162. In action 188, processor 109 uses rate control software 175 to determine a frame quantization value QP and a macroblock quantization value DQUANT. In action 190, processor 109 uses filter transfer function program 120 to translate the quantization value QP into filter control value 193. In one example, filter control value 193 is a number from one to eighteen. In action 192, processor 109 uses API 176 to translate filter control value 193 into a set of filter control values 160. In one example, the set of filter control values 160 are filter coefficients for low pass filter FILTER_LP 177 and for high pass filter FILTER_HP 178.

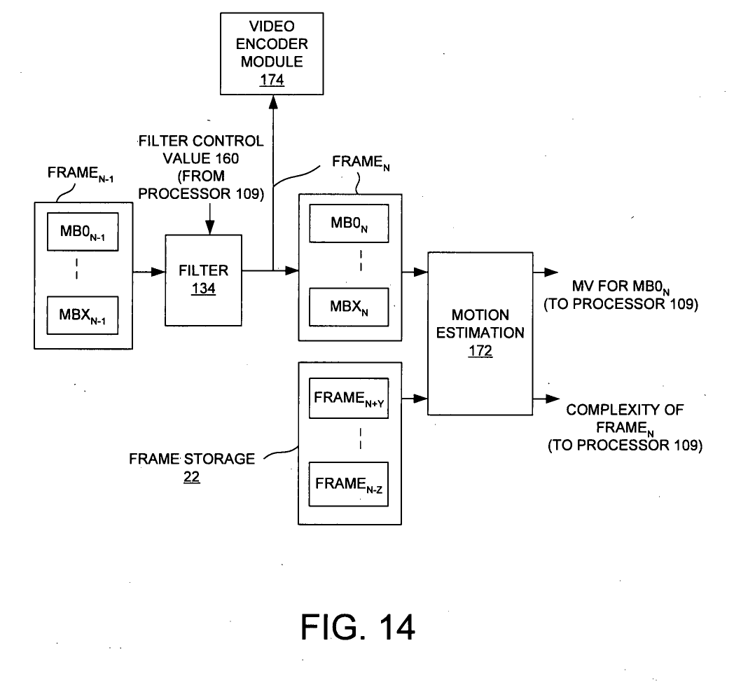

FIG. 14 is a high level block diagram illustration of how the system of FIG. 10 applies filter control values to a frame based on processing of at least one other frame, in accordance with an embodiment of the present invention. A current frame, FRAME_{N}, includes multiple macroblocks labeled MB0_{N} to MBX_{N}. Past and future frames in time in relation to current FRAME_{N} are shown as respective frames FRAME_{N-Z} and FRAME_{N+Y}, where Z and Y≧1. Respective FRAME_{N-Z} and FRAME_{N+Y} need not be immediately prior to and immediately after FRAME_{N} in display sequence. FRAME_{N-Z} and FRAME_{N+Y} are provided by frame storage 22. Motion estimation block 172 receives at least one macroblock of FRAME_{N} and motion estimation block 172 determines a motion vector for the macroblock based on one or more macroblocks from any of FRAME_{N-Z} and FRAME_{N+Y}. Determination of motion vectors is well known in the field of MPEG encoding. In one embodiment, frame storage 22 can be implemented as a non-volatile memory or SDRAM, although any type of volatile or non-volatile memory can be used.

In an embodiment, based on a filter control value 160, filter 134 applies spatial filtering to a next frame, FRAME_{N-1}, prior to MPEG encoding of FRAME_{N-1}. FRAME_{N-1} may or may not be sequential to FRAME_{N}. FRAME_{N-1} includes multiple macroblocks labeled MB0_{N-1} to MBX_{N-1}.

Although some embodiments of the present invention have been described in connection with certain specific embodiments for instructional purposes, the present invention is not limited thereto. In an embodiment, spatial filtering is applied in the MPEG encoder after summer 4 but immediately prior to DCT 8. In an embodiment, pre-processing block and MPEG encoding block can be implemented using separate integrated circuits. In an embodiment, decoding of MPEG encoded video takes place, where the MPEG encoded video includes video for which three-dimensional spatial filtering was applied to attenuate amplitudes of high horizontal and vertial spatial frequency coefficient prior to MPEG encoding of the video.

Embodiments of the present invention may be implemented as any of or a combination of: one or more microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Accordingly, various modifications, adaptations, and combinations of various features of the described embodiments can be practiced without departing from the scope of the invention as set forth in the claims.

What is claimed is:

1. An apparatus, comprising:
a video encoder that indicates at least one characteristic of a first portion of video during encoding of the first portion;
a processor that determines a filter control value based in part on the at least one characteristic; and
a pre-processing block that receives a second portion of video and applies filtering to the second portion prior to providing the second portion to the video encoder, wherein a transfer function of the filtering is based in part on the filter control value.

2. The apparatus of claim 1, wherein the video encoder applies encoding selected from a group consisting of: MPEG-1, MPEG-2, and MPEG-4.

3. The apparatus of claim 1, wherein the at least one characteristic is selected from a group consisting of: a frame complexity, macroblock complexity, motion vector for at least one macroblock, and a quantization value for a frame.

4. The apparatus of claim 1, wherein the first portion of video is taken from a group consisting of: at least one macroblock and a first frame.

5. The apparatus of claim 4, wherein the second portion of video is taken from a group consisting of: another at least one macroblock and a second frame.

6. The apparatus of claim 1, wherein the filtering comprises spatial filtering.

7. The apparatus of claim 1, wherein the filtering comprises using a digital filter used also for unsharp masking.

8. The apparatus of claim 1, wherein the filtering comprises applying a three-dimensional transfer function, wherein the pre-processing block adjusts a shape of the transfer function based in part on the filter control value.

9. The apparatus of claim 1, wherein the filtering applies a three-dimensional transfer function that is bell-shaped so that attenuation increases as horizontal or vertical spatial frequencies increase.

10. The apparatus of claim 1, wherein the filtering applies filtering along a first axis followed by filtering along second axis, wherein the first axis is selected from among a group consisting of horizontal spatial frequency and vertical spatial frequency.

11. The apparatus of claim 1, wherein the at least one characteristic is frame complexity, and wherein the frame complexity is based at least on complexities of a plurality of macroblocks in a frame.

12. The apparatus of claim 1, wherein the at least one characteristic is macroblock complexity, wherein the video encoder comprises a motion estimator that determines the macroblock complexity of the first portion of video during encoding of the first portion of video, wherein the motion estimator determines a motion vector of a macroblock of the first portion of video, and wherein the motion estimator provides the macroblock complexity and motion vector to the processor.

13. The apparatus of claim 1, wherein the video encoder further comprises a video encoder module that determines a bit count for a current macroblock, wherein the video encoder module provides the bit count to the processor and receives a bit budget for the current macroblock from the processor.

14. The apparatus of claim 1, wherein the video encoder comprises:
a motion estimator that determines a complexity of the first portion of video during encoding of the first portion of video, wherein the motion estimator determines a motion vector of a macroblock of the first portion of video, and wherein the motion estimator provides the complexity and the motion vector to the processor; and
a video encoder module that determines a bit count for a current macroblock, wherein the video encoder module provides the bit count to the processor and receives a bit budget for the current macroblock from the processor.

15. The apparatus of claim 1, wherein the pre-processing block applies to the second portion of video processing selected from a group consisting of: unsharp masking, Bayer to RGB conversion, white balance, color correction, gamma correction, and RGB to YUV color space conversion.

16. The apparatus of claim 1, wherein the filter control value is at least one digital filter coefficient.

17. A method, comprising:
(a) determining at least one characteristic of video during encoding of the video; and
(b) controlling filtering of the video prior to video encoding based on the at least one characteristic of video.

18. The method of claim 17, wherein the at least one characteristic is selected from a group consisting of: a frame complexity, macroblock complexity, motion vector for at least one macroblock, and a quantization value for a frame.

19. The method of claim 17, wherein (a) is performed by a video encoder and the at least one characteristic of video is output by the video encoder, and wherein the encoding is selected from a group consisting of: MPEG-1, MPEG-2, and MPEG-4.

20. The method of claim 17, wherein controlling filtering comprises controlling a three-dimensional shape of a transfer function applied in the filtering.

21. The method of claim 17, wherein controlling filtering comprises controlling a three-dimensional shape of a transfer function applied in the filtering, wherein the transfer function is bell-shaped, and wherein gain of the bell-shaped transfer function decreases as horizontal or vertical spatial frequencies increase.

22. The method of claim 17, wherein controlling filtering comprises controlling filtering based in part on a frame quantization value.

23. The method of claim 17, wherein the filtering comprises filtering along a first axis followed by filtering along second axis, wherein the first axis is selected from among a group consisting of horizontal spatial frequency and vertical spatial frequency.

24. A image capture device, comprising:
an MPEG encoder that applies MPEG encoding to video; and
means for filtering video, wherein the means provides video to the MPEG encoder, wherein the means adjusts the filtering based on at least one characteristic of video provided by the MPEG encoder.

25. The image capture device of claim 24, wherein the MPEG encoding is selected from the group consisting of: MPEG-1, MPEG-2, and MPEG-4.

26. The image capture device of claim 24, wherein the means for filtering has a transfer function that is a three-dimensional shape, wherein the transfer function is bell-shaped, and wherein gain of the bell-shaped transfer function decreases as horizontal or vertical spatial frequencies increase.

27. The image capture device of claim 24, wherein the means for filtering comprises a digital filter used also for unsharp masking.

28. The image capture device of claim 24, wherein the MPEG encoder provides an indication of macroblock complexity of video to the means.

29. The image capture device of claim 24, wherein the means comprises:
a spatial filter that filters the video; and
a processor that controls properties of a transfer function of the spatial filter based in part on a characteristic selected from a group consisting of: a frame complexity, macroblock complexity, motion vector for at least one macroblock, and a quantization value for a frame.
